(19) United States
(12) Patent Application Publication
(10) Pub. No.: US 2020/0044521 A1
(43) Pub. Date: Feb. 6, 2020

(54) PRODUCING A ROTOR BY MEANS OF ADDITIVE MANUFACTURING

(71) Applicant: Siemens Aktiengesellschaft, 80333 Munchen (DE)

(72) Inventors: Klaus Büttner, Hollstadt (DE); Reiner Seufert, Salz (DE); Rolf Vollmer, Gersfeld (DE)

(21) Appl. No.: 16/492,400

(22) PCT Filed: Feb. 2, 2018
(86) PCT No.: PCT/EP2018/052658

§ 371 Date: Sep. 9, 2019

(30) Foreign Application Priority Data
Mar. 10, 2017 (EP) 17160315.2

(51) Int. Cl. H02K 15/00; H02K 17/16; H02K 3/02

(52) U.S. Cl. CPC H02K 15/0012; H02K 3/02; H02K 17/165

(57) ABSTRACT

The invention relates to a method for producing a rotor of an electric machine, which rotor is preferably designed as a squirrel-cage rotor. The end rings and/or squirrel-cage bars are produced by means of a metal powder application method. The invention further relates to an end ring for a rotor of an electric machine, said end ring in particular being produced by means of said method.

The invention relates to a method for producing a rotor of an electric machine, wherein the rotor has a rotor core arranged concentrically to the rotor axis, wherein the rotor core has grooves and wherein at each of the respective axial ends of the grooves the rotor core has an annular recess which is arranged concentrically to the rotor axis and connects the grooves. The invention further relates to a short-circuit ring, in particular produced by said method, for a rotor of an electric machine.

Previously, various methods for producing a short-circuit cage, which comprises squirrel-cage bars in the rotor lamination and also short-circuit rings at the lamination ends, have been used for a rotor of an asynchronous machine.

With the copper die-casting method, the squirrel-cage bars and also the short-circuit rings are cast.

In a further known method, copper bars which have already been premanufactured are inserted into the grooves located in the rotor lamination and subsequently copper discs are soldered or welded on as short-circuit rings.

In a third known method, premanufactured copper bars are inserted into the grooves located in the rotor lamination. The grooves, however, are not completely filled. Via the aluminum die-casting method, a lower short-circuit ring is first cast by way of the channel resulting in the grooves which have not been fully filled. The grooves are subsequently filled, so that an upper short-circuit ring can be cast.

Additionally, a method is known from EP 2800254 A1 in which a granulate of an electrically conductive material is introduced into the grooves and into the annular recesses and is connected to the rotor core with a material fit by supplying heat and exerting pressure.

A method for attaching coatings to the surface of a product is known from EP 0484533 B1, wherein a metallic powder is introduced into a gas flow and said gas-powder mixture strikes the product to be coated at supersonic speed.

The patent specification US 2016/352201 A1 discloses an electric machine, e.g. generator, for motor vehicles, with a rotor unit rotating about an axis, which comprises a rotor core and a cage, wherein the cage surrounds a circumference of the rotor core, wherein the cage has impeller blades which are arranged on the ends of the rotor core.

The patent specification EP 2 953 245 A1 discloses a squirrel-cage rotor of a rotational asynchronous machine with an axially layered laminated core, with substantially axially extending grooves, in which at least one electrical conductor is located, which is at least composed of two partial conductors made of different electrically conductive materials, a short-circuit ring provided at the respective end face of the laminated core, which connects the electrical conductors, which protrude axially from the laminated core, of the respective grooves to one another in an electrically conductive manner, wherein the higher-strength material of the different electrically conductive materials faces towards the radially outer region of the groove at least in sections, viewed in the axial course of the respective groove.

Owing to the high thermal load during copper die-casting, the tools for copper die-casting have a limited service life. The electrical conductivity of the die-cast copper in the grooves is additionally reduced as a result of material contamination and blowholes.

As a result of loads due to centrifugal forces and oscillations, when soldering or welding the short-circuit ring onto the squirrel-cage bars, there is the risk of cracks forming at the resulting solder or weld points between short-circuit bar and short-circuit ring.

If, in the third method mentioned above, the groove cross-section is not completely filled with copper, then the rotor is less suitable for converter operation, in which current is immediately applied to the short-circuit cage and therefore the conductive copper causes fewer losses than aluminum.

Enlarging the surface area of the short-circuit ring and inserting slots in the same, in order to achieve an improved cooling, and also constructing cavities and channels which serve as thermosiphons, are not possible in the methods described. In addition, a material gradient cannot be brought about in the short-circuit ring, in which there is a progression from copper at the inner radius, which is in particular conductive, to steel at the outer radius, which is hard and resistant to high rotational speeds.

The object underlying the invention is to find a method for producing a rotor, which is preferably designed as a squirrel-cage rotor, of an electric machine, which enables a material-fit connection of squirrel-cage bars and rings and also, particularly in the short-circuit ring, a material gradient of at least two materials of different strengths, and the introduction of slots, openings and channels, preferably for cooling purposes, and also of cavities into the short-circuit ring. Furthermore, the object underlying the invention is to create a corresponding short-circuit ring.

The object posed is achieved by a method for producing a rotor of an electric machine, wherein the rotor has a rotor core arranged concentrically to the rotor axis, wherein the rotor core has grooves, wherein at each of the respective axial ends of the grooves the rotor core has an annular recess which is arranged concentrically to the rotor axis and connects the grooves, and wherein the grooves and/or the respective annular recess are filled with an electrically conducting material using an additive manufacturing method, wherein a material mixture of a material with a first strength, in particular copper or aluminum, and at least one material with a higher strength compared to the first strength, in particular steel or titanium, is used as material for the additive manufacturing, and wherein a material transition from a material with a first strength, in particular copper or aluminum, to at least one material with a higher strength compared to the first strength, in particular steel or titanium, is created in the axial and/or radial direction of the short-circuit ring, and wherein a short-circuit ring is embodied such that the material strength increases from the inner radius to the outer radius of the short-circuit ring, and wherein the transition is smooth.

In addition, the object is achieved by a short-circuit ring for a rotor of an electric machine, which in particular has been produced in accordance with said method.

Further advantageous embodiments are contained in the subclaims.

The invention offers the advantage that a rotor produced using an additive manufacturing method, in particular a metal powder application method (MPA method), and preferably designed as a squirrel-cage rotor, of an electric machine can be constructed from various materials. Whereas in other additive manufacturing methods such as metal laser sintering only one type of material can be used to produce a component, in the MPA method up to six different materials can be used at the same time.

It is possible to insert premanufactured copper bars into grooves located in the rotor lamination, wherein the grooves are completely filled, and subsequently to attach the short-circuit rings at the axial ends of the grooves with a material-fit connection, preferably by means of the MPA method. In addition, it is possible to produce both the squirrel-cage bars and also the short-circuit rings of the rotor using this method. In this context, first a lower part is manufactured which comprises a lower short-circuit ring and approx. half of the short-circuit bar length. Subsequently, the rotor lamination is inserted and the other half of the squirrel-cage bars and also an upper short-circuit ring are manufactured. Moreover, it is also possible to only manufacture the short-circuit rings via the MPA method.

In the MPA method, a main gas, preferably steam, is accelerated in a converging-diverging nozzle. Powder particles are injected just before the converging-diverging point. The powder particles are accelerated to supersonic speed and strike a substrate or a component accordingly. The high kinetic energy of the powder particle is converted to heat on impact, whereby the particle adheres. Since the powder particles are not melted, only a low energy input into the component takes place.

In the MPA method, a plurality of nozzles can apply various powder particles at the same time. Thus, when producing a component, a material gradient of materials with different strengths can be achieved. Thus, in a preferred embodiment, it is possible to create a short-circuit ring which has in particular conductive copper or aluminum at the inner radius for a best-possible degree of efficiency and in particular materials with a higher strength such as steel or titanium at the outer radius, in order to withstand high rotational speeds. In this context, the material gradient can be designed as smooth in both the axial and in the radial direction.

As a result of the layer-based construction of the short-circuit ring due to the MPA method, the insertion of a lattice or retaining structure made of resistant steel or titanium is also possible.

In the MPA method, it is possible to leave openings, slots and channels in the short-circuit ring for cooling purposes and manufacture enlargements of the surface area. The attachment of fan blades and balancing elements is possible.

The fact that this likewise makes it possible to leave cavities in the short-circuit ring optimizes the mass distribution and has a positive effect on the loads due to resulting centrifugal forces, as well as at higher rotational speeds.

Due to the high kinetic energy of the particles on impact, when using an MPA method, a material-fit connection of the short-circuit ring to a shaft to be joined is additionally possible.

The short-circuit ring manufactured by means of the MPA method offers the advantage that openings, in particular in the form of slots, can be implemented which facilitate cooling. Moreover, it is possible to leave channels which are particularly well-suited for use as thermosiphons. This achieves an increase in efficiency and performance of the electric machine.

The cavities which have been left in the short-circuit ring have a positive effect at high rotational speeds as a result of the mass distribution, because centrifugal forces are reduced by the center of mass shifting closer to the shaft.

Due to the material gradients in the short-circuit ring which have already been explained, and also an inserted lattice or retaining structure, preferably made of titanium or steel, it is likewise possible to bring about higher rotational speeds.

Fan blades for cooling attached via the MPA method and/or balancing elements to achieve a compensation of the mass distribution and thus a synchronous operation of the motor have a positive effect on the efficiency and performance of the motor.

The material-fit connection of the short-circuit ring to the shaft enables higher rotational speeds.

A short-circuit cage, which is completely manufactured from copper, is particularly well-suited for converter operation, since in this context current is immediately applied to the short-circuit cage and it therefore must be highly conductive. As a result of the higher conductivity of copper compared to aluminum, it is particularly possible for short-circuit rings made of copper to be manufactured more compactly.

The invention is described and explained in more detail below on the basis of the exemplary embodiments shown in the figures, in which:

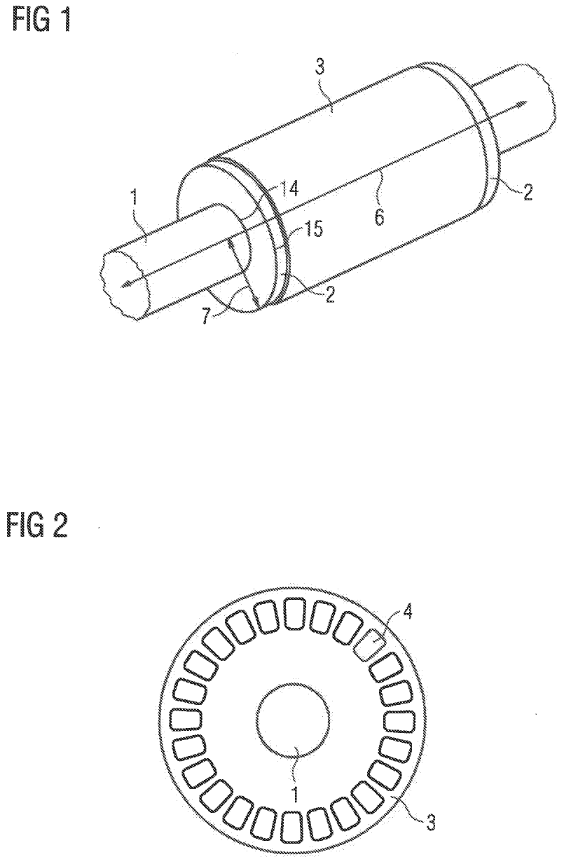

FIG. 1 shows an embodiment of a rotor joined to a shaft, which rotor includes a rotor core and two short-circuit rings,

FIG. 2 shows an embodiment of the rotor core, which has grooves,

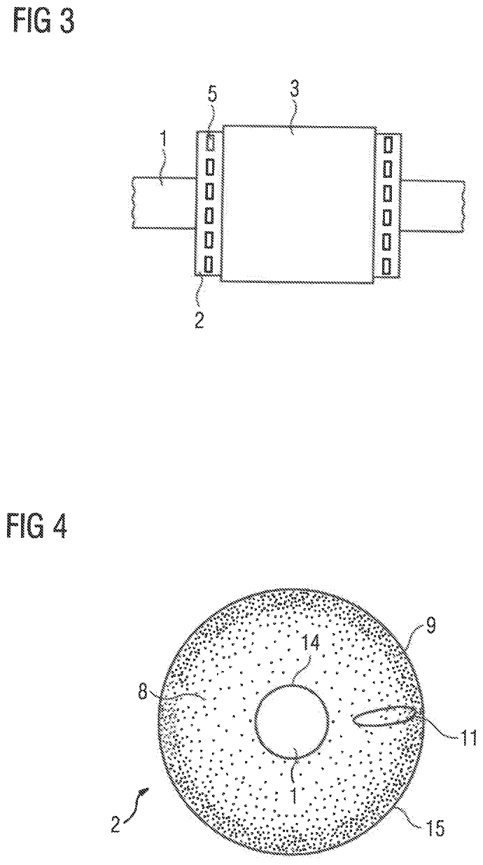

FIG. 3 shows an embodiment of the rotor joined to the shaft, wherein the two short-circuit rings have openings,

FIG. 4 shows an embodiment of a material gradient in the short-circuit ring, wherein the transition between the materials is smooth,

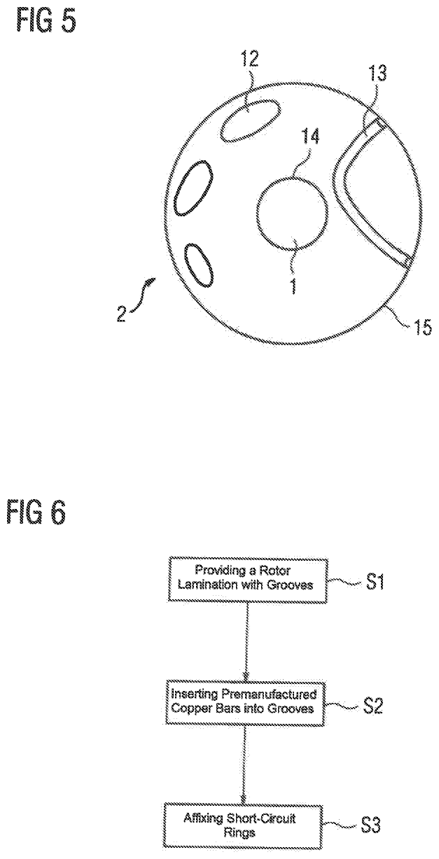

FIG. 5 shows an embodiment of the short-circuit ring provided with at least one cavity and at least one channel,

FIG. 6 shows the procedure of the manufacturing method.

FIG. 1 shows an embodiment of a rotor joined to a shaft 1, which has a rotor core 3 and a short-circuit ring 2 at each of its axial ends. In addition, the axial direction 6 and the radial direction 7 are shown, as well as the inner radius 14 and the outer radius 15 of the short-circuit ring. Preferably, the rotor is designed as a squirrel-cage rotor and comprises squirrel-cage bars, which extend in the axial direction 6 or obliquely substantially in the axial direction 6, as well as short-circuit rings 2 on the axial ends of the squirrel-cage bars, which short-circuit said bars. According to the invention, it is possible for only the squirrel-cage bars or only the short-circuit rings 2 or the squirrel-cage bars and the short-circuit rings 2 to be manufactured by means of the MPA method. Advantageously, the squirrel-cage bars are premanufactured, preferably from copper or aluminum, and inserted into the rotor core 3 and subsequently the short-circuit rings 2 are affixed by means of an MPA method. A short-circuit ring 2 produced by means of the MPA method offers the advantage that cavities, channels and openings can be inserted in particular. A material gradient is also possible, in which a transition between two materials with different strength is brought about in the axial 6 and/or radial direction 7.

FIG. 2 shows an embodiment of the rotor core 3, which is joined to a shaft 1 and has grooves 4 in the axial direction 6. The grooves can be filled with premanufactured squirrel-cage bars and subsequently the short-circuit rings are affixed via the MPA method.

FIG. 3 shows an embodiment of the rotor joined to the shaft 1. The short-circuit rings 2 are provided with openings 5, which are preferably designed as slots, and serve for cooling purposes.

FIG. 4 shows an embodiment of a material gradient in a short-circuit ring 2, in which a transition from a material with a first strength, in particular copper or aluminum, to a material with a higher strength compared to the first, in particular steel or titanium, is created in the radial direction 7 (see FIG. 1). At the inner radius 14 of the short-circuit ring 2, which borders on the shaft 1, an electrically conductive material such as copper is attached in order to short-circuit the squirrel-cage bars introduced into the grooves. At the outer radius 15, material is introduced which is resistant to centrifugal forces, such as steel. In FIG. 5, a smooth transition 11 between the two materials 8 and 9 is shown. A material gradient which has a smooth transition 11 of two or more materials 8 and 9 is also possible in the axial direction 6. Since the short-circuit rings 2 are affixed to the respective axial ends of the rotor by means of the MPA method, a material-fit connection to the shaft 1 is possible.

FIG. 5 shows an embodiment of the short-circuit ring 2 provided with cavities 12 and channels 13. The cavities are situated particularly closer to the outer radius 15 than to the inner radius 14, in order to shift the center of mass close to the shaft 1 and thus to reduce centrifugal forces. The channels are particularly well-suited for use as thermosiphons, in order to preferably benefit the heat flow in the direction of the shaft 1.

FIG. 6 describes a procedure of a manufacturing method for a rotor according to the invention of an electric machine. In accordance with one preferred type of production of the rotor designed as a squirrel-cage rotor, a rotor lamination, which possesses grooves, is provided in method step S1. Subsequently in method step S2, copper bars, which have already been premanufactured, are inserted into the available grooves. These fulfill the function of the squirrel-cage bars of the squirrel-cage rotor. Following this, in method step S3, short-circuit rings are affixed to the axial ends of the squirrel-cage bars by means of an MPA method.

1.-16. (canceled)

17. A method for producing a rotor of an electric machine, said method comprising:
arranging a rotor core concentrically to a rotor axis;
forming the rotor core at an axial end of grooves in the rotor core with an annular recess in concentric relation to the rotor axis for connecting the grooves; and
creating a short-circuit ring by filling the grooves and the annular recess through an additive manufacturing process with an electrically conducting material based on a material mixture of a material with a first strength and a material with a second strength which is higher than the first strength, with a smooth material transition from the material with the first strength to the material with the second strength being created in an axial direction and/or radial direction of the short-circuit ring such that a material strength increases from an inner radius to an outer radius of the short-circuit ring,
wherein the additive manufacturing process establishes in the short-circuit ring a retaining structure or a lattice which is made of the material with the second strength.

18. The method of claim 17, wherein the additive manufacturing process includes a metal powder application process.

19. The method of claim 17, wherein the electrically conducting material is copper or aluminum or alloys thereof.

20. The method of claim 17, wherein the grooves are filled with premanufactured material and the annular recess is filled by a metal powder application process for creating the short-circuit ring.

21. The method of claim 17, wherein an opening and/or a cavity and/or a channel is left in the short-circuit ring as the annular recess is filled with the electrically conducting material.

22. The method of claim 17, wherein the retaining structure or the lattice in the short-circuit ring is made of titanium or steel.

23. The method of claim 17, wherein the short-circuit ring has a surface structure.

24. The method of claim 23, wherein the surface structure is configured in the form of a blade and/or a balancing element.

25. The method of claim 17, further comprising joining the short-circuit ring by a material-fit connection to a shaft.

26. The method of claim 17, wherein the material with the first strength is copper or aluminum and the material with the second strength is steel or titanium.

27. A rotor of an electric machine, comprising:
a rotor core arranged concentrically to a rotor axis, said rotor core having grooves and an annular recess at each axial end of the grooves in concentric relation to the rotor axis for connecting the grooves; and
a short-circuit ring formed by filling the grooves and the annular recess with electrically conducting material using an additive manufacturing process with a material mixture of a material with a first strength and a material with a second strength which is higher than the first strength, said short-circuit ring having openings left therein.

28. The rotor of claim 27, wherein the openings are configured as slots.

29. The rotor of claim 27, wherein the short-circuit ring has cavities and/or channels.

30. The rotor of claim 27, wherein the material with the first strength is copper or aluminum, and the material with the second strength is steel or titanium.

31. The rotor of claim 27, wherein the short-circuit ring has a material transition from the material with the first strength to the material with the second strength in an axial direction and/or radial direction of the short-circuit ring.

32. The rotor of claim 27, wherein the short-circuit ring includes a retaining structure or a lattice formed by the additive manufacturing process of the material with the second strength.

33. The rotor of claim 32, wherein the retaining structure or the lattice is made of titanium or steel.

34. The rotor of claim 27, wherein the short-circuit ring has a surface structure in the form of a blade and/or a balancing element.

35. The rotor of claim 27, further comprising a shaft joined to the short-circuit ring by a material-fit connection and made of steel.

36. An electric machine, comprising a rotor, said rotor comprising a rotor core arranged concentrically to a rotor axis, said rotor core having grooves and an annular recess at each axial end of the grooves in concentric relation to the rotor axis for connecting the grooves; and a short-circuit ring formed by filling the grooves and the annular recess with electrically conducting material using an additive manufacturing process with a material mixture of a material with a first strength and a material with a second strength which is higher than the first strength, said short-circuit ring having openings left therein.
